(19) United States
(12) Patent Application Publication
(10) Pub. No.: US 2018/0164764 A1
(43) Pub. Date: Jun. 14, 2018

(54) Apparatus and Method for Analysis of Machine Performance

(71) Applicant: General Electric Company, Schenectady, NY (US)

(72) Inventors: Paul Weatherbee, Edmonton (CA); Michael Behnke, San Ramon, CA (US); Nilesh Dixit, San Ramon, CA (US)

(21) Appl. No.: 15/375,435

(22) Filed: Dec. 12, 2016

(51) Int. Cl. G05B 19/048

(52) U.S. Cl. CPC G05B 19/048; G05B 2219/24015

(57) ABSTRACT

Asset performance management (APM) information associated with an industrial machine that is producing a product is obtained. At least one of machine operation information and output characteristic information is received from the industrial machine. The APM information, the machine operation information, and the output characteristic information are stored in a database at the cloud (or some other remote computing device or network). The APM information, the machine operation information, and the output characteristic information are analyzed at the cloud to identify in real-time changes to the operation of the machine needed to improve the performance of the industrial machine. In some aspects, the changes are presented to a user and the changes are acted upon.

### BACKGROUND OF THE INVENTION

### Field of the Invention

The subject matter disclosed herein generally relates to machines, and, more specifically, optimizing the performance of these machines.

### Brief Description of the Related Art

Various types of industrial machines are used to perform various operations and tasks in the manufacturing, energy production, transportation, water treatment and other operations and tasks. For instance, some machines are used to create and finish parts associated with wind turbines. Other machines are used to create mechanical parts or components utilized by vehicles. Still other machines are used to produce electrical parts (e.g., resistors, capacitors, and inductors to mention a few examples). Typically, industrial machines, as well as other complex machines used in heavy industry, healthcare and related environments, are controlled at least in part by computer code (or a computer program) that is executed by a processor that is located at the machine.

It is often desirable to optimize the performance of such machines, for example, those operating in a facility. Various data from the machine may be reviewed by a human operator to determine whether the machine is operating properly. However, there are numerous types of data that need to be analyzed and this sometimes overwhelms human operators. Additionally, other types of data may not even be available to the human operator making the analysis difficult or impossible to complete.

Previous attempts to address these problems have been made, but unfortunately, have not been successful.

### BRIEF DESCRIPTION OF THE INVENTION

The present invention monitors the health of machines in a facility (e.g. a factory, maintenance facility, hospital or other area containing complex machines) and obtains efficiency characteristics to determine a maintenance schedule for that machine. For example, historical downtime data of machines/parts may be analyzed and this is combined with the predicted downtime of the machines/parts to determine optimized operating parameters for the facility including, e.g., a maintenance schedule of the machine. The invention herein may optionally be implemented using a computerized industrial internet of things analytics platform that may be deployed at the location of the manufacturing process, at the manufacturing facility premise or in the cloud.

Some of these embodiments may optionally obtain asset performance management (APM) information associated with a machine. At least one of machine operation information and output dimension information is received from the machine. The APM information, the machine operation information, and the output characteristic information are stored in a database at the cloud or some other remote computing device. The APM information includes information relating to managing the performance of the machine (e.g., operator assignment). The machine operation information relates to a physical operating characteristic of the machine (e.g., an operating speed). The output characteristic information relates to a dimension or other measurable physical characteristic (e.g., length or weight) of the product or output produced by the machine. The APM information, the machine operation information, and the output characteristic information are analyzed at the cloud (or some other remote computing device or network) to identify changes to the operation of the machine needed to improve the performance of the industrial machine. The changes can be identified in real time. In some aspects, the changes are presented to a user and the changes are acted upon in a variety of different ways. User input can be received to implement the changes.

In some examples, the APM information may include the temperature in the environment around a machine, an identity of the operator of the machine, or a program being executed by the industrial machine. Other examples are possible.

In other examples, the output characteristic comprises a measurement of the product or output of the machine. For instance, the measurement may be a width, a length, a thickness, a temperature, or a pressure of the product. Other examples are possible.

In yet other examples, patterns of past behavior are used to predict future machine performance, and adjustments needed to maintain the machine are made based upon the predictions. In examples, the predictions specify whether the machine will be operating correctly in the future.

In others of these embodiments, an apparatus deployed at the cloud (or some other remote computing device or network) includes an interface, a database, and a control circuit. The interface includes an input and an output. The input is configured to receive APM information associated with a machine that is producing a product (or creating an output) and at least one of: machine operation information and output characteristic information from the industrial machine.

The database stores the APM information, the machine operation information, and the output characteristic information. The control circuit is coupled to the interface and the database. The control circuit is configured to analyze the APM information, the machine operation information, and the output characteristic information at a remote computing device or network (e.g., the cloud) and to responsively identify in real-time changes to the operation of the machine needed to improve the performance of the industrial machine.

### BRIEF DESCRIPTION OF THE DRAWINGS

For a more complete understanding of the disclosure, reference should be made to the following detailed description and accompanying drawings wherein:

FIG. 1 comprises a block diagram of a system for optimizing machine performance including information flow in the system according to various embodiments of the present invention;

FIG. 2 comprises a block diagram of a system for optimizing machine performance according to various embodiments of the present invention;

FIG. 3 comprises a flowchart of an approach for optimizing machine performance according to various embodiments of the present invention;

FIG. 4 comprises a flowchart showing one approach for analyzing information and determining an action as a result of the analysis according to various embodiments of the present invention; and

FIG. 5 comprises a block diagram showing an implementation for a system for optimizing machine behavior according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

With the present approaches, various asset performance management (APM) information may be obtained and stored in a database (e.g., at the cloud). For instance, information concerning the temperature around a machine at a plant, the operator of the machine, and the program the machine is using may be collected and stored. The machine may produce a product that has certain characteristics. This information is analyzed (e.g., at the cloud) to determine in real-time if changes to the machine or operator of the machine need to be made.

To take one specific example, a cutting tool may be used to make parts. Parts made by the machine may be measured, characteristics (e.g., speed of the machine) may be obtained, and APM characteristics (e.g., temperature around machine) obtained. These are analyzed to see if the machine is operating correctly (e.g., an analysis may determine if the tool is dull). If a correction needs to be made, the machine may receive a new blade. This data and the corrections made can be collected and used to make predictions of future machine behavior. Thus, if the same facts occur in the future, a similar correction can be made.

Advantageously, the present approaches find variances in products and correct the variances in real-time. Machine operation also does not necessarily need to be halted (or halted for prolonged periods of time). The abilities to make changes in real-time without necessarily halting a production line are particularly important in maintaining the efficient and cost-effective operation of assembly lines.

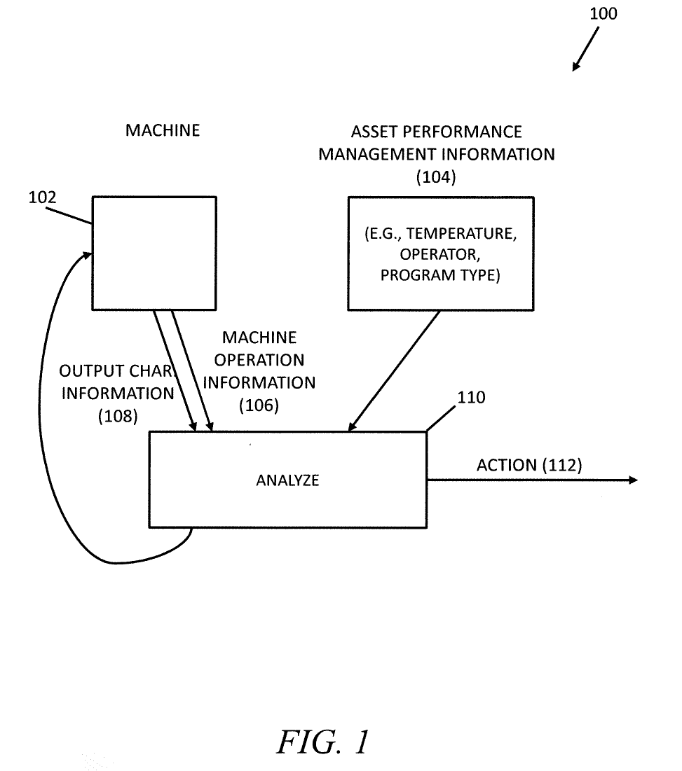

Referring now to FIG. 1, one example of a system 100 for optimizing performance of a machine 102 is described. Asset performance management (APM) information 104 associated with the industrial machine 102 that is producing a product is obtained. In some examples, the APM information 104 is the temperature in the environment around a machine, an identity of the operator of the machine, or a program being executed by the industrial machine. Other examples are possible

Machine operation information 106 and/or output characteristic information 108 is received from the industrial machine 102. In examples, the machine operation 106 includes the speed or temperature of the machine. In examples, the output characteristic information 108 comprises a physical measurement of the product. For instance, the measurement may be a measurement of a width, a length, a thickness, a temperature, or a pressure of the product. Other examples are possible.

The APM information 104, the machine operation information 106, and the output characteristic information 108 may be stored in a database at the cloud and are analyzed (e.g., at the cloud) at step 110 to identify in real-time changes to the operation of the machine needed to improve the performance of the industrial machine. Step 110 may be executed at the cloud, in one example. In other examples, step 110 may be executed at a remote location such as at a factory or plant.

The changes that are determined can be implemented as a variety of different actions. For example, once the changes are identified, an action 112 is created, but the action 112 is not returned or sent to the machine 102 (e.g., the action 112 may be implemented as an alert message that is sent to a user that asks the user to perform some task that makes the operation of the machine 102 more efficient).

The changes may also be implemented as an action 114 that is sent to the machine 102 (e.g., the action 114 may be implemented as a control signal that changes the operation of the machine 102 or an alert to the operator of the machine). As a result of the actions taken, the operation of the machine 102 can be optimized in real time.

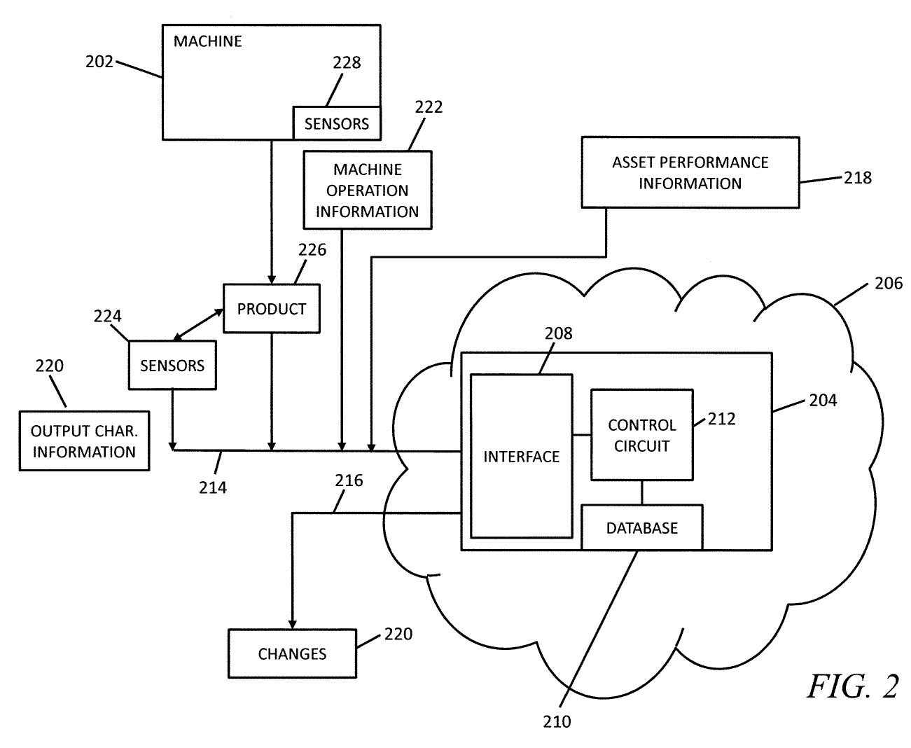

Referring now to FIG. 2, one example of a system 200 for optimizing machine performance is described. The system 200 includes a machine 202 (making a product 226), and an apparatus 204 deployed at a cloud network 206. Although the apparatus 204 is shown as deployed at the cloud 206, it will be appreciated that it also may be deployed at a remote or edge location (e.g., at the factory where the machine 202 is deployed, or at a control center not located at the cloud 206).

The apparatus 204 deployed at the cloud 206 includes an interface 208, a database 210, and a control circuit 212. The interface 208 includes an input 214 and an output 216. The input 214 is configured to receive asset performance management (APM) information 218 associated with the industrial machine 204 that is producing a product, output characteristic information 220 from sensors 224 (that measure physical characteristics of the product 226 produced by the industrial machine), and machine operation information 222 from sensors 228 (that measure characteristics of the operation of the machine 202).

The cloud 206 is a network that may include routers, gateways, or any other type of communication devices. The cloud 206 is remotely located from the machine 202.

The machine 202 may be any type of industrial machine such as a cutter, grinder, or capper to mention a few examples. The machine 202 may be in a grouping of machines (the machine may be a wind turbine in a wind farm) or may be part of an assembly line. Other examples of machines and their groupings are possible.

The sensors 224 may be any type of sensing device that sense or measure any type of physical characteristic of the product 226. For example, the length, width, thickness or weight of the product 226 may be measured by the sensors 224. The sensors 228 may measure any characteristic of the machine 202 such as the temperature or pressure of the machine 202.

As mentioned, apparatus 204 includes an interface 208, database 210, and control circuit 212. The interface 208 is any combination of hardware and/or software that allows the apparatus 204 to communicate with other electronic or non-electronic entities. The interface 208 may perform conversion, transmission, and reception functions. The database 210 is any type of memory storage device that stores the APM information 218, the machine operation information 222, and the output characteristic information 220 once this information is received.

The control circuit 212 is any combination of computer hardware and/or software. In aspects, the control circuit 212 is a microprocessor executing computer instructions that are stored in a memory (e.g., the database 210). The control circuit 212 is coupled to the interface 208 and the database 210. The control circuit 212 is configured to analyze the APM information 218, the machine operation information 222, and the output characteristic information 220 at the cloud 206 and to responsively identify in real-time changes to the operation of the machine 202 needed to improve the performance of the industrial machine 202. Changes 230 may be identified by the control circuit 212 and output at the output 216 of the interface 208.

In some examples, the APM information 218 is the temperature in the environment around a machine, an identity of the operator of the machine, or a program being executed by the industrial machine. Other examples are possible.

In examples, the output characteristic information 220 comprises a measurement of the product. For instance, the measurement may be a width, a length, a thickness, a temperature, or a pressure of the product. Other examples are possible.

In other aspects, adjustments needed to the machine are made by the control circuit 212 based upon predicted future machine behavior. To take one example, the patterns of characteristics (e.g., incorrect part sizing, rising machine temperature, too slow spindle speed), may be stored in a data structure (e.g., a lookup table) in a database 210, and the entries in the data structure linked to an action (e.g., send an alert). Thus, once similar or suspect patterns are identified in current machine operation, actions can be taken before machine operation becomes a problem (e.g., the machine begins to produce incorrectly sized parts).

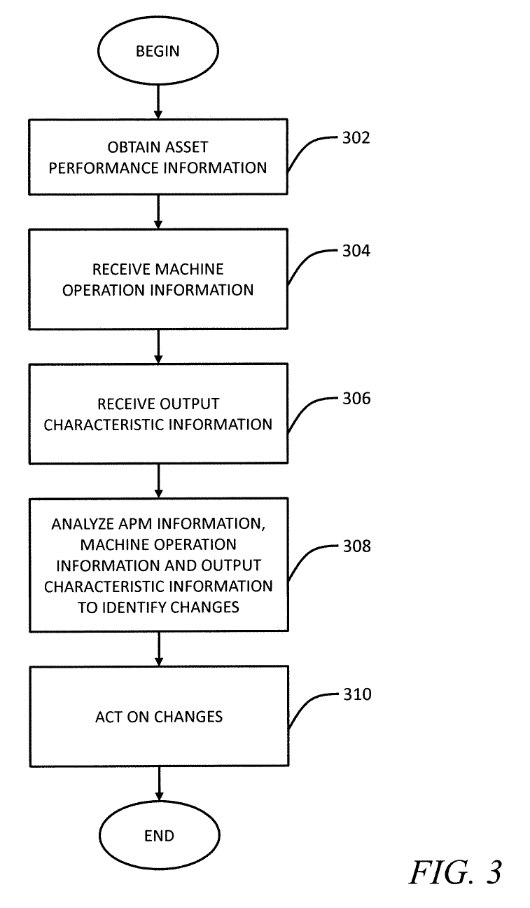

Referring now to FIG. 3, one example of an approach for optimizing machine performance is described. At step 302, asset performance management (APM) information associated with an industrial machine that is producing a product is obtained. This information may be stored at the cloud. In some examples, the APM information is the temperature in the environment around a machine, an identity of the operator of the machine, or a program being executed by the industrial machine. Other examples are possible.

At step 304, machine operation information is obtained. This information may be stored at the cloud. In examples, this information may include the speed or temperature of the machine. Other examples are possible.

At step 306, output characteristic information is received from the industrial machine. This information may be stored at the cloud. In examples, the output characteristic information comprises a measurement of the product. For instance, the measurement may be a width, a length, a thickness, a temperature, or a pressure of the product. Other examples are possible. This information can be obtained by various sensors (e.g., cameras), or any type of measurement device.

At step 308, the APM information, the machine operation information, and the output characteristic information are analyzed at the cloud to identify in real-time changes to the operation of the machine needed to improve the performance of the industrial machine. In examples, the analyzing determines whether the machine is operating correctly. For instance, when the machine is a cutting tool, certain results of an analysis of the APM information, the machine operation information, and the output characteristic information may indicate that the tool is becoming dull and should be changed.

At step 310, the changes identified in step 308 are acted upon or implemented. In some aspects, the changes are presented to a human user and the changes are acted upon by the user. In one example, a human operator may be asked to change a part in the machine. In another example, operators may be switched when it is determined that it is more efficient for a particular human operator to operate the machine. Other examples are possible.

In still other examples, the changes may be implemented automatically. For example, machine operation can be changed to implement desired changes.

In yet other examples, adjustments needed to the machine are determined based upon patterns of past behavior or operation of the machine (or based upon other factors). To take one example, the patterns of characteristics (e.g., incorrect part sizing, rising machine temperature, too slow spindle speed), may be stored in a data structure (e.g., a lookup table) in a database, and the entries in the data structure linked to an action (e.g., send an alert). Thus, once similar or suspect patterns are identified in current machine operation, actions can be taken before machine operation becomes a problem (e.g., the machine begins to produce parts that are incorrectly sized).

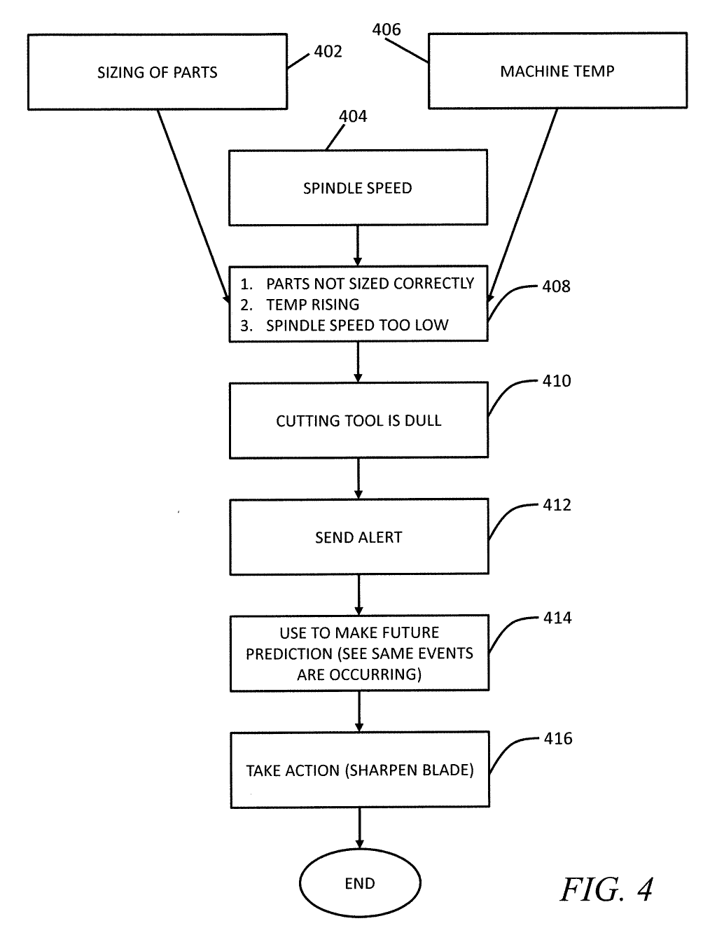

Referring now to FIG. 4, one example of an approach for analyzing information to optimize machine performance is described. In this example, the machine is a cutting tool that is used to machine or create parts. The machine has a rotating spindle with a blade (that cuts or trims parts), and first sensors that determine or measure physical characteristics of the machine, second sensors that measure the speed of the spindle, and third sensors that measure the temperature of the machine. It will be appreciated that the approach of FIG. 4 is one example and that other examples are possible. The example of FIG. 4 may be implemented as any combination of hardware and/or software. For example, the approach of FIG. 4 may be implemented by a microprocessor executing computer instructions that are stored in a computer memory.

With steps 402, 404, and 406, information is received. At step 402, the sizing of parts created by the machines is received. For example, the first sensors may measure physical dimensions of the parts (e.g., length, width, thickness, diameter, weight, mass, internal pressure, the temperature of the part, to mention a few examples). At step 404, the second sensors return the spindle speed. At step 406, the third sensors return the temperature of the machine.

At step 408, the parameters returned at steps 402, 404, and 406 are analyzed. For example, these parameters may be individually compared to predetermined thresholds to see whether the parameters are within acceptable limits. In the present example, it is determined that the parts are not sized correctly, that the machine temperature is rising, and that the spindle speed is too slow (e.g., the spindle speed falls below a predetermined threshold).

At 410, a conclusion is formed based upon the results of step 408. For example (and in this case), when the parts are incorrectly sized, the temperature is rising, and the spindle speed is too slow, the conclusion is that the tool is dull. Other combinations from step 408 may yield different conclusions. For example, when the parts are not sized correctly, but the temperature and spindle speed are within acceptable limits, this may indicate a human operator error. When all three factors are acceptable, the conclusion is that the machine is operating properly. It will be understood that there are many variations to the conclusions that can be reached at step 410 and these depend upon the nature of the machine and the product that it is producing. It will also be appreciated that this step may be implemented as a mapping between the conditions and the conclusion. For instance, a lookup table (or any other appropriate data structure) may be used to implement the mapping. Other examples are possible.

At step 412, an action occurs based upon the conclusion at step 410. In this case, an alert may be sent to a machine operator to change the blade on the machine. The action itself may include a large number of actions. For example, a control signal may be formed to perform the action automatically (e.g., automatically sending the alert). If a control signal is generated, the control signal can be used to directly control the operation of a machine (e.g., activating the machine, deactivating the machine, increasing the operating speed of the machine, or decreasing the operating speed of the machine to mention a few examples).

At step 414, the information obtained in the proceeding steps may be used to make future predictions of machine behavior, and adjustments to the machine may be made based upon these predictions. Thus, if the temperature is rising and the spindle speed is slowing, and the sizing of the parts are changing, a conclusion may be made that the blade of the machine is becoming dull (and at some point, the part will become unacceptable for usage).

To take one example, the patterns of characteristics (incorrect part sizing, rising machine temperature, too slow spindle speed), may be stored in a data structure (e.g., a lookup table) in a database, and the entries in the data structure linked to an action (e.g., send an alert). Thus, once similar or suspect patterns are identified in current machine operation, actions can be taken before machine operation becomes a problem (e.g., the machine begins to produce incorrectly sized parts).

At step 416, an action (or actions) can be taken as a result of the conclusion reached at step 414. In this example, an alert may be issued to a machine operator to sharpen the blade of the machine. As before, a control signal may be formed to perform the action automatically (e.g., automatically sending the alert). If a control signal is generated, the control signal can be used to directly control the operation of a machine (e.g., activating the machine, deactivating the machine, increasing the operating speed of the machine, or decreasing the operating speed of the machine to mention a few examples).

As mentioned, the approaches described herein may optionally be implemented using a computerized industrial internet of things analytics platform that may be deployed at the location of the manufacturing process, at the manufacturing facility premise, or in the cloud.

While progress with industrial equipment automation has been made over the last several decades, and assets have become “smarter,” the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance if appropriate industrial-specific data collection and modeling technology is developed and applied.

In an example, an industrial asset can be outfitted with one or more sensors configured to monitor respective ones of an asset's operations or conditions. Data from the one or more sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, or to enhanced software algorithms for operating the same or similar asset at its edge, that is, at the extremes of its expected or available operating conditions.

The systems and methods for managing industrial machines (also referred to assets herein) can include or can be a portion of an Industrial Internet of Things (IIoT). In an example, an IIoT connects industrial assets, such as turbines, jet engines, and locomotives, to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with and configuration of industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets.

The Predix™ platform available from GE is a novel embodiment of such Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

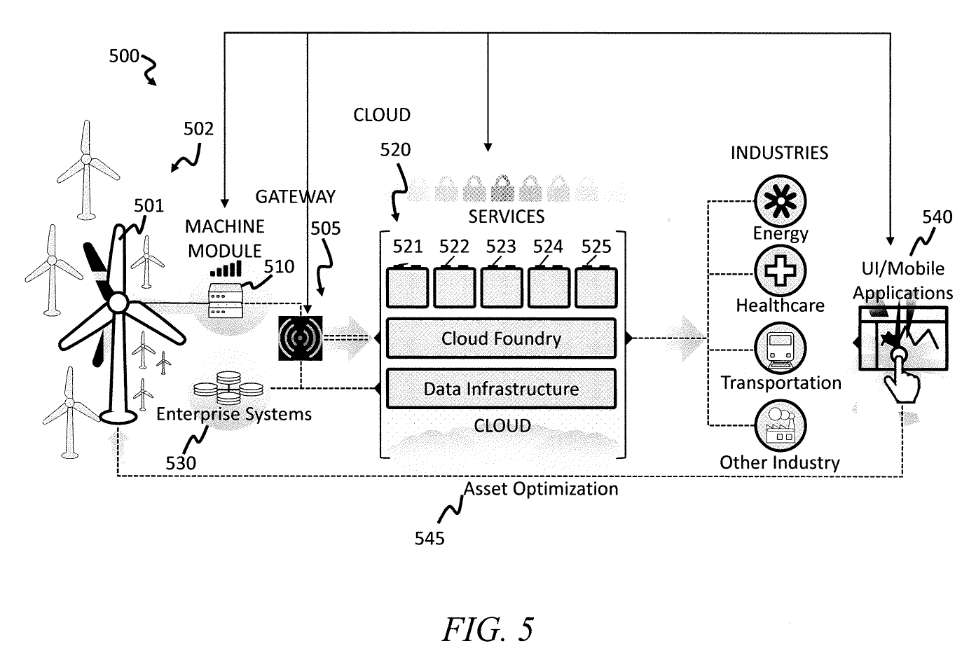

FIG. 5 illustrates generally an example of portions of a first AMP 500. As further described herein, one or more portions of an AMP can reside in an asset cloud computing system 520, in a local or sandboxed environment, or can be distributed across multiple locations or devices. An AMP can be configured to perform any one or more of data acquisition, data analysis, or data exchange with local or remote assets, or with other task-specific processing devices.

The first AMP 500 includes a first asset community 502 that is communicatively coupled with the asset cloud computing system 520. In an example, a machine module 510 receives information from, or senses information about, at least one asset member of the first asset community 502, and configures the received information for exchange with the asset cloud computing system 520. In an example, the machine module 510 is coupled to the asset cloud computing system 520 or to an enterprise computing system 530 via a communication gateway 505.

In an example, the communication gateway 505 includes or uses a wired or wireless communication channel that extends at least from the machine module 510 to the asset cloud computing system 520. The asset cloud computing system 520 includes several layers. In an example, the asset cloud computing system 520 includes at least a data infrastructure layer, a cloud foundry layer, and modules for providing various functions. In the example of FIG. 5, the asset cloud computing system 520 includes an asset module 521, an analytics module 522, a data acquisition module 523, a data security module 524, and an operations module 525. Each of the modules 521-525 includes or uses a dedicated circuit, or instructions for operating a general purpose processor circuit, to perform the respective functions. In an example, the modules 521-525 are communicatively coupled in the asset cloud computing system 520 such that information from one module can be shared with another. In an example, the modules 521-525 are co-located at a designated datacenter or other facility, or the modules 521-525 can be distributed across multiple different locations.

An interface device 540 can be configured for data communication with one or more of the machine module 510, the gateway 505, or the asset cloud computing system 520. The interface device 540 can be used to monitor or control one or more assets. In an example, information about the first asset community 502 is presented to an operator at the interface device 540. The information about the first asset community 502 can include information from the machine module 510, or the information can include information from the asset cloud computing system 520. In an example, the information from the asset cloud computing system 520 includes information about the first asset community 502 in the context of multiple other similar or dissimilar assets, and the interface device 540 can include options for optimizing one or more members of the first asset community 502 based on analytics performed at the asset cloud computing system 520.

In an example, an operator selects a parameter update for the first wind turbine 501 using the interface device 540, and the parameter update is pushed to the first wind turbine via one or more of the asset cloud computing system 520, the gateway 505, and the machine module 510. In an example, the interface device 540 is in data communication with the enterprise computing system 530 and the interface device 540 provides an operation with enterprise-wide data about the first asset community 502 in the context of other business or process data. For example, choices with respect to asset optimization can be presented to an operator in the context of available or forecasted raw material supplies or fuel costs. In an example, choices with respect to asset optimization can be presented to an operator in the context of a process flow to identify how efficiency gains or losses at one asset can impact other assets. In an example, one or more choices described herein as being presented to a user or operator can alternatively be made automatically by a processor circuit according to earlier-specified or programmed operational parameters. In an example, the processor circuit can be located at one or more of the interface device 540, the asset cloud computing system 520, the enterprise computing system 530, or elsewhere.

Returning again to the example of FIG. 5 some capabilities of the first AMP 500 are illustrated. The example of FIG. 5 includes the first asset community 502 with multiple wind turbine assets, including the first wind turbine 501. Wind turbines are used in some examples herein as non-limiting examples of a type of industrial asset that can be a part of, or in data communication with, the first AMP 500.

In an example, the multiple turbine members of the asset community 502 include assets from different manufacturers or vintages. The multiple turbine members of the asset community 502 can belong to one or more different asset communities, and the asset communities can be located locally or remotely from one another. For example, the members of the asset community 502 can be co-located on a single wind farm, or the members can be geographically distributed across multiple different farms. In an example, the multiple turbine members of the asset community 502 can be in use (or non-use) under similar or dissimilar environmental conditions, or can have one or more other common or distinguishing characteristics.

FIG. 5 further includes the device gateway 505 configured to couple the first asset community 502 to the asset cloud computing system 520. The device gateway 505 can further couple the asset cloud computing system 520 to one or more other assets or asset communities, to the enterprise computing system 530, or to one or more other devices. The first AMP 500 thus represents a scalable industrial solution that extends from a physical or virtual asset (e.g., the first wind turbine 501) to a remote asset cloud computing system 520. The asset cloud computing system 520 optionally includes a local system, enterprise, or global computing infrastructure that can be optimized for industrial data workloads, secure data communication, and compliance with regulatory requirements.

In an example, information from an asset, about the asset, or sensed by an asset itself is communicated from the asset to the data acquisition module 524 in the asset cloud computing system 520. In an example, an external sensor can be used to sense information about a function of an asset, or to sense information about an environment condition at or near an asset. The external sensor can be configured for data communication with the device gateway 505 and the data acquisition module 524, and the asset cloud computing system 520 can be configured to use the sensor information in its analysis of one or more assets, such as using the analytics module 522.

In an example, the first AMP 500 can use the asset cloud computing system 520 to retrieve an operational model for the first wind turbine 501, such as using the asset module 521. The model can be stored locally in the asset cloud computing system 520, or the model can be stored at the enterprise computing system 530, or the model can be stored elsewhere. The asset cloud computing system 520 can use the analytics module 522 to apply information received about the first wind turbine 501 or its operating conditions (e.g., received via the device gateway 505) to or with the retrieved operational model. Using a result from the analytics module 522, the operational model can optionally be updated, such as for subsequent use in optimizing the first wind turbine 501 or one or more other assets, such as one or more assets in the same or different asset community. For example, information about the first wind turbine 501 can be analyzed at the asset cloud computing system 520 to inform selection of an operating parameter for a remotely located second wind turbine that belongs to a different second asset community.

The first AMP 500 includes a machine module 510. The machine module 510 includes a software layer configured for communication with one or more industrial assets and the asset cloud computing system 520. In an example, the machine module 510 can be configured to run an application locally at an asset, such as at the first wind turbine 501. The machine module 510 can be configured for use with or installed on gateways, industrial controllers, sensors, and other components. In an example, the machine module 510 includes a hardware circuit with a processor that is configured to execute software instructions to receive information about an asset, optionally process or apply the received information, and then selectively transmit the same or different information to the asset cloud computing system 520.

In an example, the asset cloud computing system 520 can include the operations module 525. The operations module 525 can include services that developers can use to build or test Industrial Internet applications, or the operations module 525 can include services to implement Industrial Internet applications, such as in coordination with one or more other AMP modules. In an example, the operations module 525 includes a microservices marketplace where developers can publish their services and/or retrieve services from third parties. The operations module 525 can include a development framework for communicating with various available services or modules. The development framework can offer developers a consistent look and feel and a contextual user experience in web or mobile applications.

In an example, an AMP can further include a connectivity module. The connectivity module can optionally be used where a direct connection to the cloud is unavailable. For example, a connectivity module can be used to enable data communication between one or more assets and the cloud using a virtual network of wired (e.g., fixed-line electrical, optical, or other) or wireless (e.g., cellular, satellite, or other) communication channels. In an example, a connectivity module forms at least a portion of the gateway 505 between the machine module 510 and the asset cloud computing system 520.

In an example, an AMP can be configured to aid in optimizing operations or preparing or executing predictive maintenance for industrial assets. An AMP can leverage multiple platform components to predict problem conditions and conduct preventative maintenance, thereby reducing unplanned downtimes. In an example, the machine module 510 is configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit applies analytics or algorithms at the machine module 510 or at the asset cloud computing system 520.

In response to the detected error conditions, the AMP can issue various mitigating commands to the asset, such as via the machine module 510, for manual or automatic implementation at the asset. In an example, the AMP can provide a shut-down command to the asset in response to a detected error condition. Shutting down an asset before an error condition becomes fatal can help to mitigate potential losses or to reduce damage to the asset or its surroundings. In addition to such an edge-level application, the machine module 510 can communicate asset information to the asset cloud computing system 520.

In an example, the asset cloud computing system 520 can store or retrieve operational data for multiple similar assets. Over time, data scientists or machine learning can identify patterns and, based on the patterns, can create improved physics-based analytical models for identifying or mitigating issues at a particular asset or asset type. The improved analytics can be pushed back to all or a subset of the assets, such as via multiple respective machine modules 510, to effectively and efficiently improve performance of designated (e.g., similarly-situated) assets.

In an example, the asset cloud computing system 520 includes a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration can be useful when an application requires an underlying hardware configuration. The provisioning management and pooling of resources can be done at a granular level, thus allowing optimal resource allocation.

In a further example, the asset cloud computing system 520 is based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The asset cloud computing system 520 can include a data services module that can facilitate application development. For example, the data services module can enable developers to bring data into the asset cloud computing system 520 and to make such data available for various applications, such as applications that execute at the cloud, at a machine module, or at an asset or other location. In an example, the data services module can be configured to cleanse, merge, or map data before ultimately storing it in an appropriate data store, for example, at the asset cloud computing system 520. A special emphasis has been placed on time series data, as it is the data format that most sensors use.

Security can be a concern for data services that deal in data exchange between the asset cloud computing system 520 and one or more assets or other components. Some options for securing data transmissions include using Virtual Private Networks (VPN) or an SSL/TLS model. In an example, the first AMP 500 can support two-way TLS, such as between a machine module and the security module 524. In an example, two-way TLS may not be supported, and the security module 524 can treat client devices as OAuth users. For example, the security module 524 can allow enrollment of an asset (or other device) as an OAuth client and transparently use OAuth access tokens to send data to protected endpoints.

In the example of FIG. 5, it will be understood that the approaches described herein with respect to FIGS. 1-4 may be implemented using the AMP 500 that may be deployed at the first asset community 502, at the wind turbine 501, or in the cloud 520. In one example, the apparatus 204 of FIG. 2 may be deployed at any of these locations.

It will be appreciated by those skilled in the art that modifications to the foregoing embodiments may be made in various aspects. Other variations clearly would also work, and are within the scope and spirit of the invention. It is deemed that the spirit and scope of that invention encompasses such modifications and alterations to the embodiments herein as would be apparent to one of ordinary skill in the art and familiar with the teachings of the present application.

What is claimed is:

1. A method, comprising:
receiving asset performance management (APM) information associated with a machine that is producing an output, the APM information including information relating to managing the performance of the machine;
receiving at least one of: machine operation information and output characteristic information from the machine, the machine operation information describing a physical operating characteristic of the machine, and the output characteristic information describing a measurable physical characteristic of the output;
storing the APM information, the machine operation information, and the output characteristic information in a database at a remote computing device;
analyzing the APM information, the machine operation information, and the output characteristic information at the remote computing device to identify changes to optimize the performance of the industrial machine.

2. The method of claim 1 further comprising presenting the changes to a user and receiving input from the user to implement the changes.

3. The method of claim 1, wherein the APM information is the temperature in the environment around a machine, an identity of the operator of the machine, or a program being executed by the industrial machine.

4. The method of claim 1, wherein the output characteristic information comprises a measurement of the output.

5. The method of claim 4, wherein the measurement comprises a width, a length, a thickness, a temperature, or a pressure of the output.

6. The method of claim 1, wherein said analyzing further comprises making a prediction of future behavior of the machine.

7. The method of claim 1, wherein the analyzing further comprises determining whether the machine is operating within one or more specifications.

8. The method of claim 1, wherein the remote computing device is the cloud.

9. An apparatus deployed at the cloud, comprising:
an interface, the interface configured to receive asset performance management (APM) information associated with an industrial machine that is producing an output, the APM information including information relating to managing the performance of the machine, the interface receiving at least one of: machine operation information and output characteristic information from the industrial machine, the machine operation information describing a physical operating characteristic of the machine, and the output characteristic information describing a measurable physical characteristic of the output;
a database that stores the APM information, the machine operation information, and the output characteristic information;
a control circuit coupled to the interface and the database, the control circuit configured to analyze the APM information, the machine operation information, and the output characteristic information at a remote computing device and to responsively identify changes to the optimize the performance of the industrial machine.

10. The apparatus of claim 9, further comprising presenting the changes to the user and receiving input from the user to implement the changes.

11. The apparatus of claim 9, wherein the control circuit is configured to transmit a control signal to implement at least some of the changes.

12. The apparatus of claim 9, wherein the APM information is the temperature in the environment around a machine, an identity of the operator of the machine, or a program being executed by the industrial machine.

13. The apparatus of claim 9, wherein the output characteristic information comprises a measurement of the output.

14. The apparatus of claim 13, wherein the measurement comprises a width, a length, a thickness, a temperature, or a pressure of the output.

15. The apparatus of claim 9, wherein the control circuit is further configured to determine a prediction of future machine behavior.

16. The apparatus of claim 9, wherein the control circuit determines whether the machine is operating within one or more specifications.

17. The apparatus of claim 9, wherein the remote computing device is the cloud.
